(19) United States
(12) Patent Application Publication
(10) Pub. No.: US 2026/0097747 A1
(43) Pub. Date: Apr. 9, 2026

(54) ELECTRIC DISC BRAKE SYSTEM

(71) Applicant: TRP International, LLC, Elkhart, IN (US)

(72) Inventors: Tanner Nicholas Skrove, Elkart, IN (US); Andrew Alger, Goshen, IN (US); Trey Dumph, Nappanee, IN (US); Fredric Buckingham, Edwardsburg, MI (US)

(21) Appl. No.: 19/414,539

(22) Filed: Dec. 10, 2025

Related U.S. Application Data
(63) Continuation-in-part of application No. 17/818,438, filed on Aug. 9, 2022, now Pat. No. 12,509,046.
(60) Provisional application No. 63/230,896, filed on Aug. 9, 2021.

(51) Int. Cl. B60T 8/17; B60T 1/06; B60T 8/171; B60T 13/74

(52) U.S. Cl. CPC B60T 8/1708; B60T 1/065; B60T 8/171; B60T 13/741; B60T 13/746; B60T 2220/04

(57) ABSTRACT

An electric disc brake system for a trailer. The brake system employs a caliper assembly that is attached to the trailer with floating fasteners, wherein the caliper assembly straddles an axle mounted rotor positioning an inner and outer brake pad adjacent to the rotor. A screw drive assembly is attached to the caliper. The assembly includes an electric motor coupled to a piston by a threaded shaft. The screw drive assembly converts rotation of the electric motor into linear motion to movement of the piston, wherein the inner and outer brake pads engage the rotor based upon the amount of pressure applied by the piston. A controller reacts to the pressure applied to a brake pedal to cause the electric motor to rotate in a clockwise or counter-clockwise direction.

### PRIORITY CLAIM

In accordance with 37 C.F. R. 1.76, a claim of priority is included in an Application Data Sheet filed concurrently herewith. Accordingly, the present invention claims priority to U. S. Patent Application No. 17/818438 entitled ELECTRIC DISC BRAKE SYSTEM'' filed August 9, 2022, further claiming priority to U.S. Provisional Patent Application No. 63/230,896, entitled ELECTIC BRAKE SYSTEM FOR A UTILITY TRAILER filed August 9 2 022 the contents of which are incorporated herein by reference.

### BACKGROUND OF THE INVENTION

Trailers may be towed behind passenger vehicles including cars and pick-up trucks. Trailer can be further defined to include boat trailers, camper trailers, open and enclosed cargo trailers, RV trailers, horse trailers, and so forth. Trailers are used to haul most anything that will fit within the dimensions of the trailer, or serve as a platform for items that may exceed the trailer dimensions.

Trailers are unique in that they can be designed to carry loads and can be secured to most any type of vehicle capable of supporting the load. Unfortunately, trailers can be quickly overloaded resulting in changes to the vehicle towing ability. The result is that a trailer may be loaded into a condition that is unsuitable for towing by the vehicle. For instance, a trailer may be overloaded with weight which can exceed the capacity of the towing vehicle, especially the stopping ability. It is well known that consumers who own trailers do not weigh every item placed thereon, and there is no law that requires the consumer purchase a particular towing vehicle designed for the load size. Even if a larger vehicle is employed, such as a truck with a fifth wheel, the condition of the towing vehicle may not meet the desired specifications due to worn brakes, worn tire threads, and so forth. Further, road conditions can change the vehicles towing ability, such as sloped, wet or snow covered pavement. No matter what size the towing vehicle is, if the characteristics of the towing do not match the trailer requirements, the towing vehicle and trailer can form a dangerous combination on the open road.

A necessity with towing a trailer is to make sure the towing vehicle is able to stop the forward momentum of the trailer, or the trailer has the ability to slow or stop itself. If the momentum of a trailer exceeds the braking capacity of the towing vehicle, the trailer will continue with forward movement in respect to the trailer mass, leaving the towing vehicle with reduced braking capacity. Should fast deceleration be required, a trailer may overtake the towing vehicle, resulting in a jackknife condition. Should the pavement be wet, a trailer can easily exceed a towing vehicle’s control limitations and become a liability.

Trailers commonly employ hydraulic or electric actuated brakes. Hydraulic brakes are complex and expensive, but have high braking force. Electric drum brakes are simple to install and inexpensive, but lack the braking force recognized by hydraulic disc brake systems.

The cost and complexity of trailer braking systems becomes the basis for some consumers to avoid brake installation altogether, choosing to rely upon the towing vehicle’s braking system. However, most vehicles are not designed to accommodate the additional load placed on the braking system by a trailer. Further, even if a large vehicle is towing a trailer, certain road conditions demand the use of trailer mounted brakes to prevent jackknifing or like trailer induced situations.

The importance of trailer braking cannot be emphasized enough. The National Highway Traffic Safety Administration (NHTSA) reports an average no less than 400 deaths each year in the United States because of an accident involving a trailer. Trailer accidents represent approximately 3% of all fatalities involving passenger vehicles.

What is needed in the industry is an electric braking system for a trailer that is more efficient and lower in cost than conventional braking systems.

### SUMMARY OF THE INVENTION

Disclosed is an electric disc brake system for a trailer that creates braking force by turning rotational motion of a threaded shaft into linear motion for movement of a piston. The electric disc brake system comprises a caliper assembly attached to the trailer with floating fasteners, allowing the caliper assembly to straddle an axle mounted rotor. An inner brake pad is slidably secured to the caliper and juxtapositioned to an inner surface of the rotor. An outer brake pad is slidably secured to the caliper and juxtapositioned to an outer surface of the rotor. A power screw assembly is attached to the caliper and employs an electric motor coupled to a piston by use of a screw drive. The screw drive converts rotation of the motor into linear motion to push the piston, wherein the inner and outer brake pads engage the rotor based upon the amount of pressure applied by the piston. A controller reacts to the pressure applied to a brake pedal to cause the electric motor to rotate in a clockwise or counter-clockwise direction.

An objective of the invention is to provide a low-cost trailer braking system for trailers that would improve the safety of trailers while incorporating existing components such as the axle, rotor, and calipers from a conventional disc brake system.

Another objective of the invention is to teach the use of an electric disc brake system that can provide the braking force of hydraulic brakes.

Other objectives, benefits and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a pictorial view of electric disc brake system components of a first embodiment;

FIG. 2 is an exploded view thereof;

FIG. 3 is a pictorial view of an exposed threaded shaft and piston;

FIG. 4 is an exploded view of the spacer and piston assembly;

FIG. 5A is a perspective view of the piston;

FIG. 5B is a cross-sectional view of the piston;

FIG. 6A is a perspective view of the threaded shaft;

FIG. 6B is a cross-sectional view of the threaded shaft;

FIG. 7A provides the calculations for motor torque requirement;

FIG. 7B provides the calculations for the threaded shaft linear velocities and forces;

FIG. 8 is a block diagram of the electric system;

FIG. 9 is a flow diagram of the Arduino program;

FIG. 10 is a perspective view of another embodiment of an electric disc brake system;

FIG. 11 is an exploded view thereof;

FIG. 12 is a pictorial view of electric disc brake system components of a second embodiment on a rotor;

FIG. 13 is a pictorial of the second embodiment without a rotor; and

FIG. 14 is an exploded view thereof.

### DESCRIPTION OF THE PREFERRED EMBODIMENT

It is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

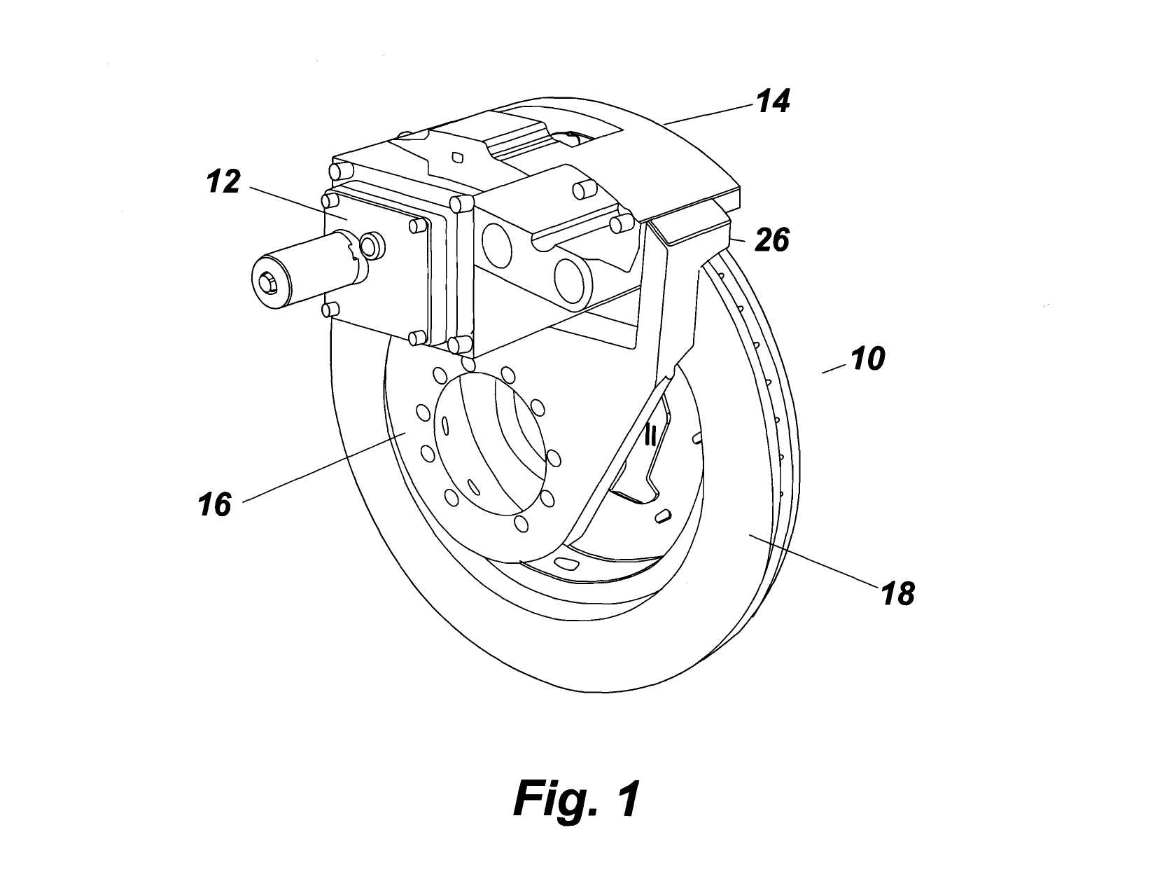

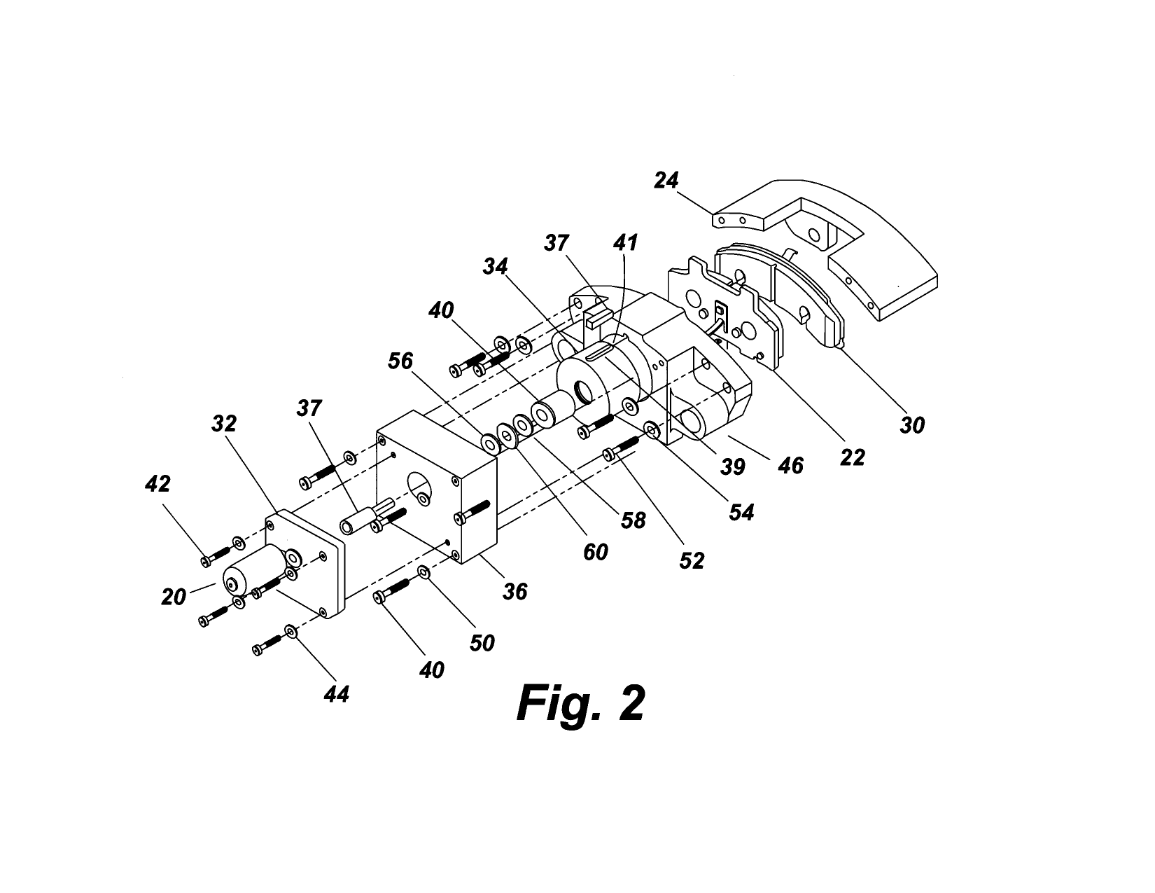

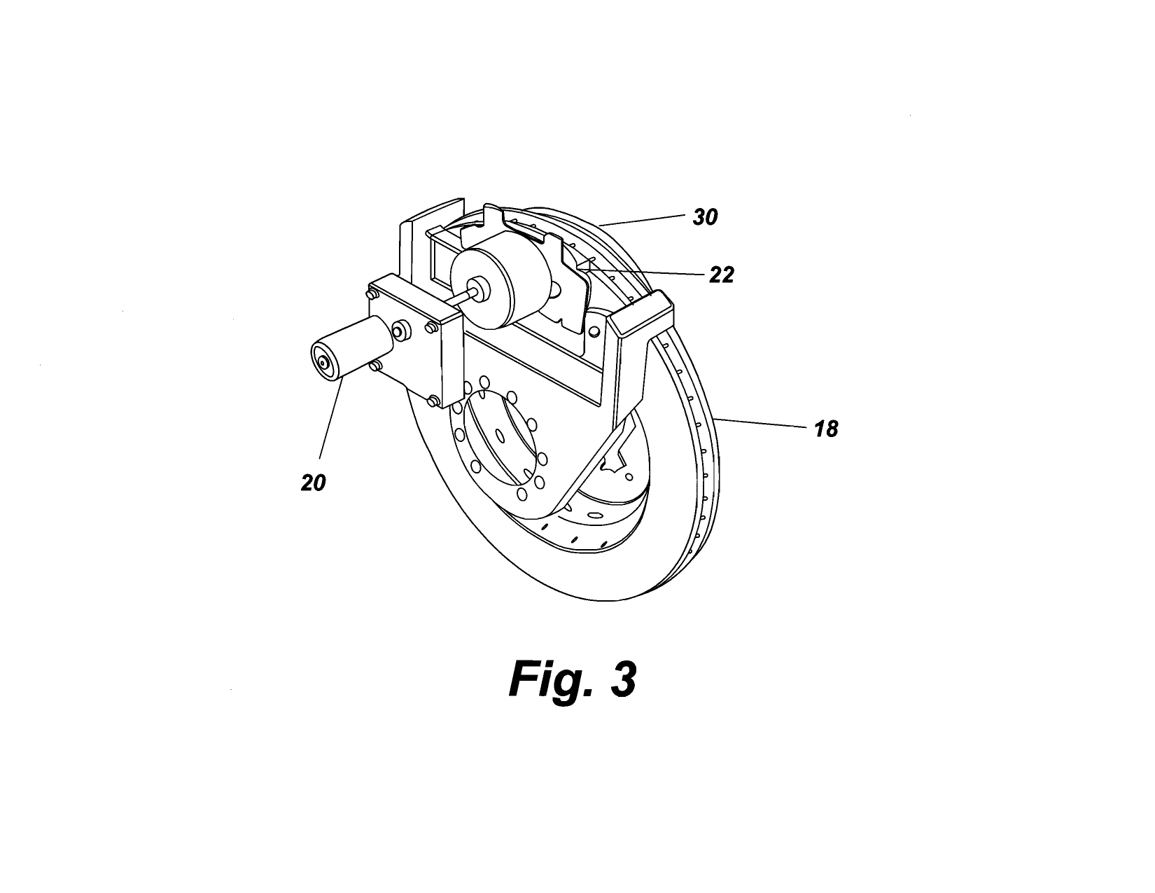

Referring now to FIGS. 1-3, depicted is the electric disc brake assembly 10 comprising a power screw assembly 12 mounted to a caliper 14 by a caliper mounting bracket 16 positioned about a rotor 18. The power screw assembly 12 converts rotation of an electric motor 20 into linear motion to push an inner brake pad 22 onto the rotor 18, which causes the entire caliper assembly 24 to move on floating fasteners 26 that attach it to the mounting bracket 16. The caliper assembly 24 moves until the outer brake pad 30 contacts the rotor 18 and wherein a clamping force is applied between the brake pads 22 and 30 to slow the rotor 18. Once the brakes are released, the motor 20 rotates in the opposite direction to release the pressure on the brake pads 22 and 30 against the rotor 18.

The power screw assembly 12 employs an electric motor 20 coupled to a motor support 32 which is spaced apart from a drive piston 34 by a spacer 36. The motor 20 has a motor shaft extension 37 converting rotation of the electric motor 20 into linear motion by use of a threaded shaft 40 to push the inner brake pad 22 onto the rotor 18, which further draws the caliber assembly 24 causes an equal force to be applied against the outer brake pad 30. The electric motor 20 and motor support 32 are coupled to the spacer 36 by a plurality of fasteners 42 and associated washers 44. The spacer 36 is coupled to the caliper base 46 by a plurality of spacer fasteners 48 and associated washers 50. The caliper 24 is coupled to the caliper base 46 by caliper fasteners 52 and associated washers 54. The motor shaft extension 37 is operatively associated with the threaded shaft 40 using thrust washers 56 and 58, and a needle thrust bearing 60. Electrical power provided to the motor 20 causes the threaded shaft 40 to rotate, causing the brake pads 22 and 30 to contact the rotor 18 when the threaded shaft 40 is rotated in one direction, and retracts the brake pads 22 and 30 from contacting with the rotor 18 when the threaded shaft 40 is rotated in an opposite direction.

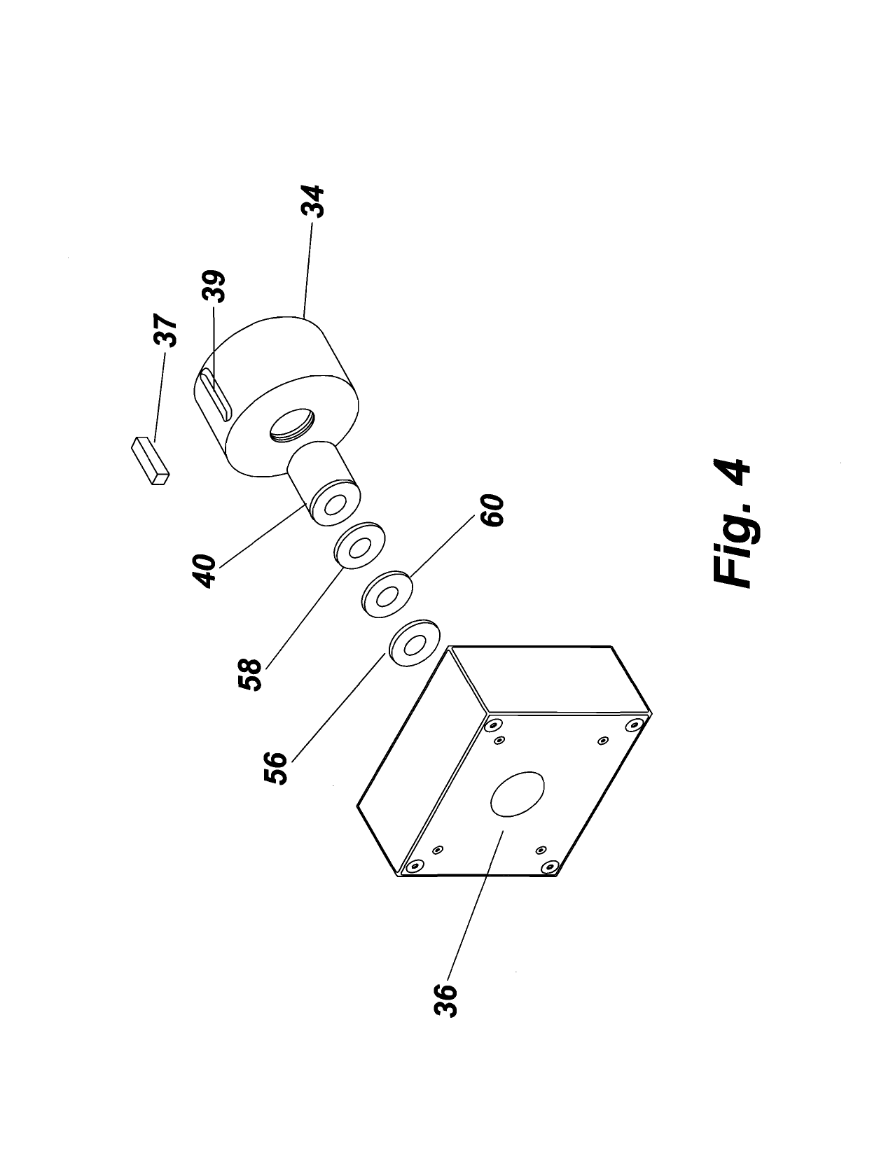

FIG. 4 depicts the threaded shaft 40 and piston assembly 34. The threaded shaft 40 pushes the piston 34 outward into the brake pads, causing the brake pads 22, 30 to clamp the rotor 18. The piston 34 is prevented from rotating in place by a key 37 for placement in alignment slot 39; the caliper base 46 having an adjoining slot 41. The resulting force directed back at the motor 20 is taken by the thrust washers 56 and 58 and is transferred through the spacer 36. The motor 20 does not bear any load through the motor shaft 37.

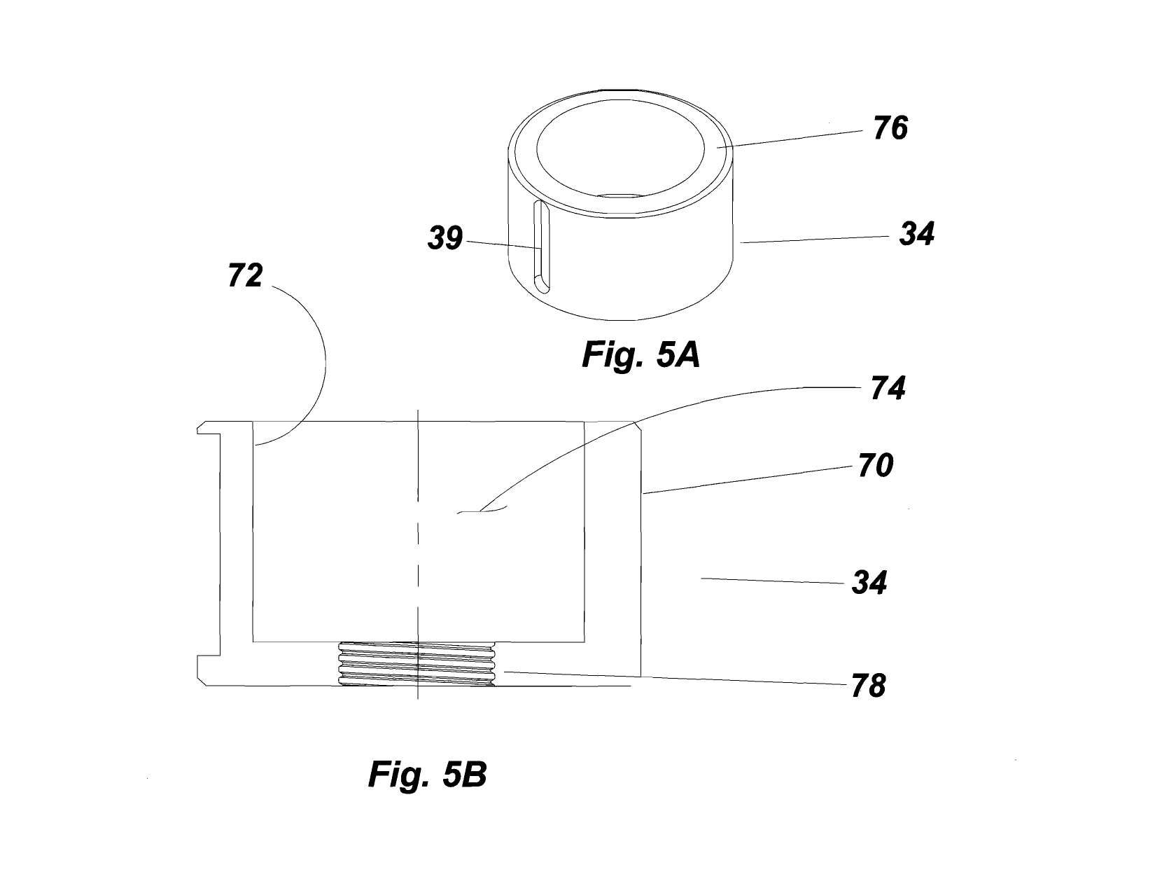

FIGS. 5A and 5B depict the piston 34 having a cylindrical outer wall 70 and an inner wall 72 forming a chamber 74 with a brake pad engagement surface 76 and a threaded aperture 78 for receipt of the threaded shaft 40. The alignment slot 39 is formed in the outer wall 70.

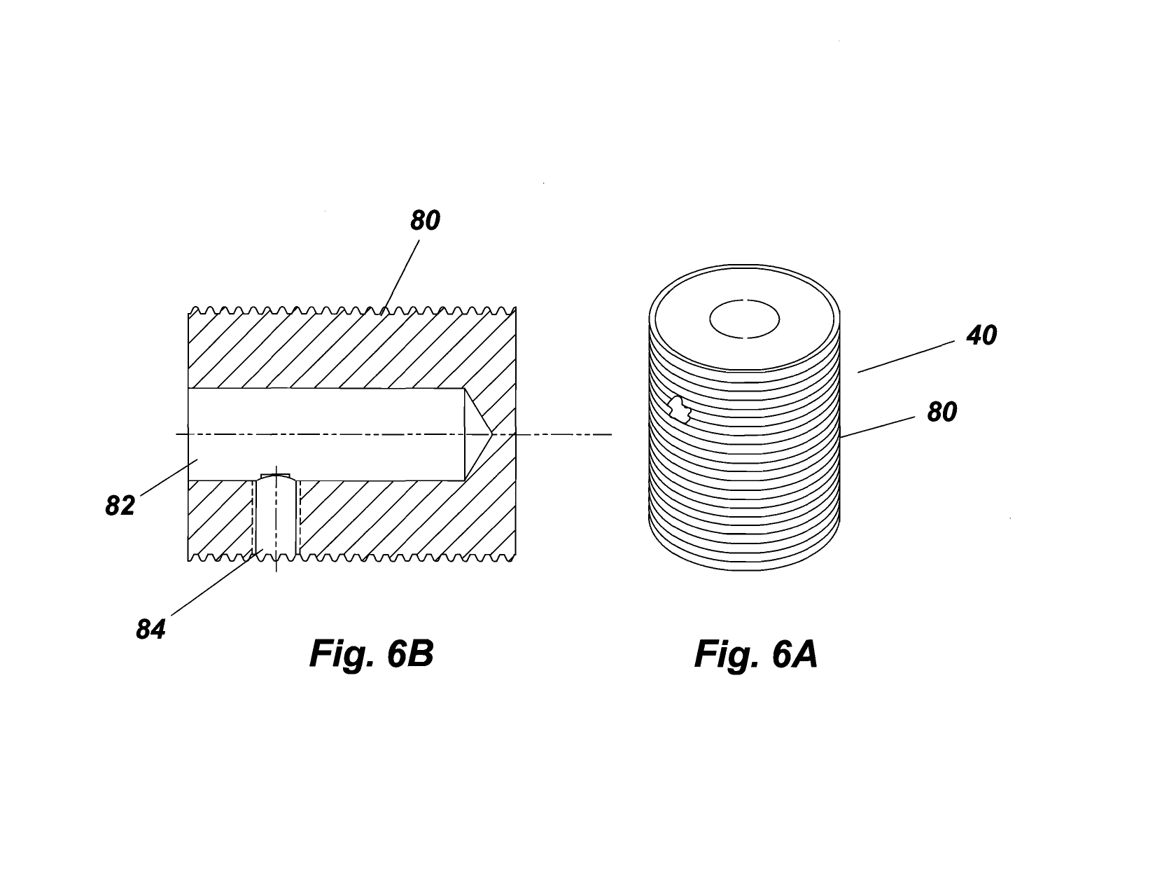

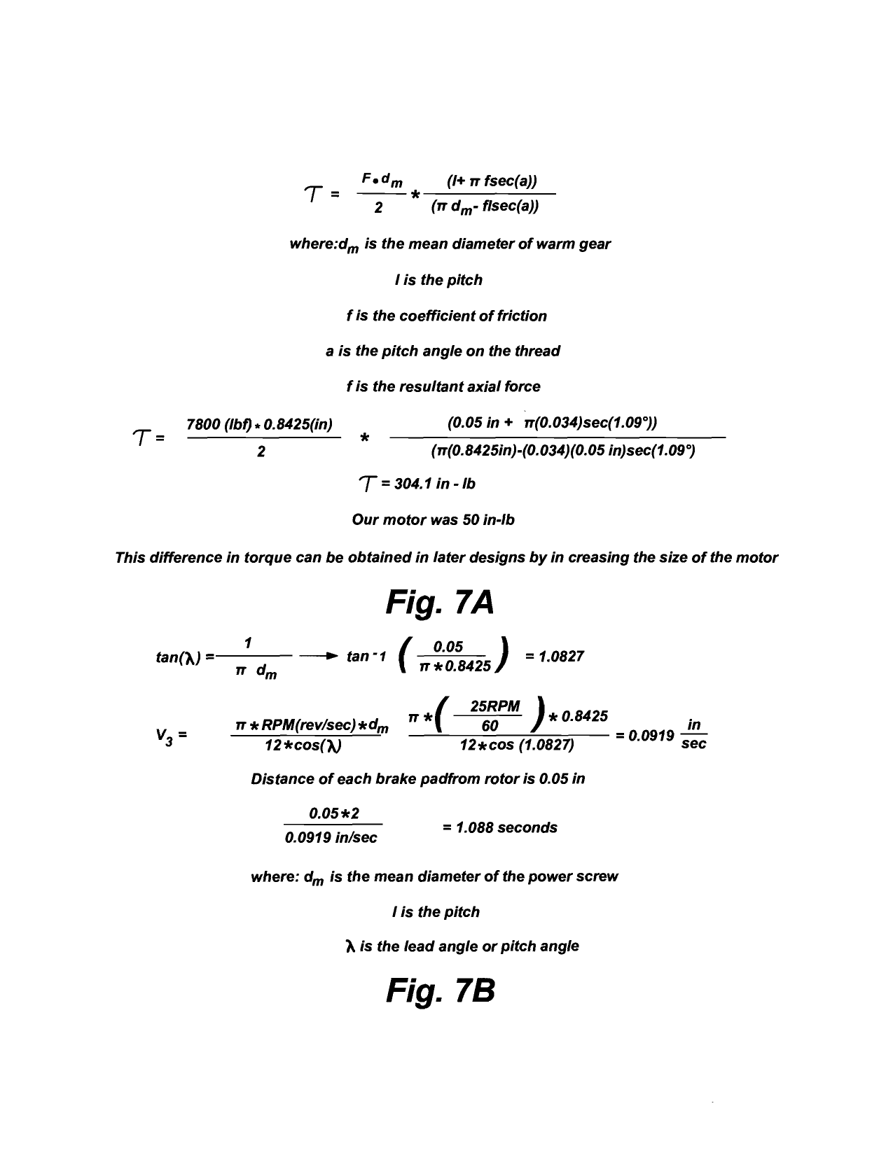

FIGS. 6A and 6B depict the threaded shaft 40 having a threaded outer surface 80 constructed and arranged to engage the piston threaded aperture 78. The threaded shaft 80 includes a shaft receptacle 82 for receipt of the shaft extension 37. Set screw receptacle 84 is used to lock the shaft extension 37 to the threaded shaft 80. FIG. 7A provides the calculations for determining torque requirement of the motor based upon the gear pitch and resultant axial force. Referring to FIG. 7B, the calculations illustrate the linear velocities and forces found for a preferred embodiment of a preferred threaded shaft 40 and threaded outer surface 80, because of its size and mechanical advantage, using a standard thread. However, design iterations may include a custom, finer thread to increase mechanical advantage. The threaded outer surface 80 cannot be too fine, otherwise friction will become a factor. Friction is a key element to the system since it allows for constant braking force once the threaded shaft 80 fully engages.

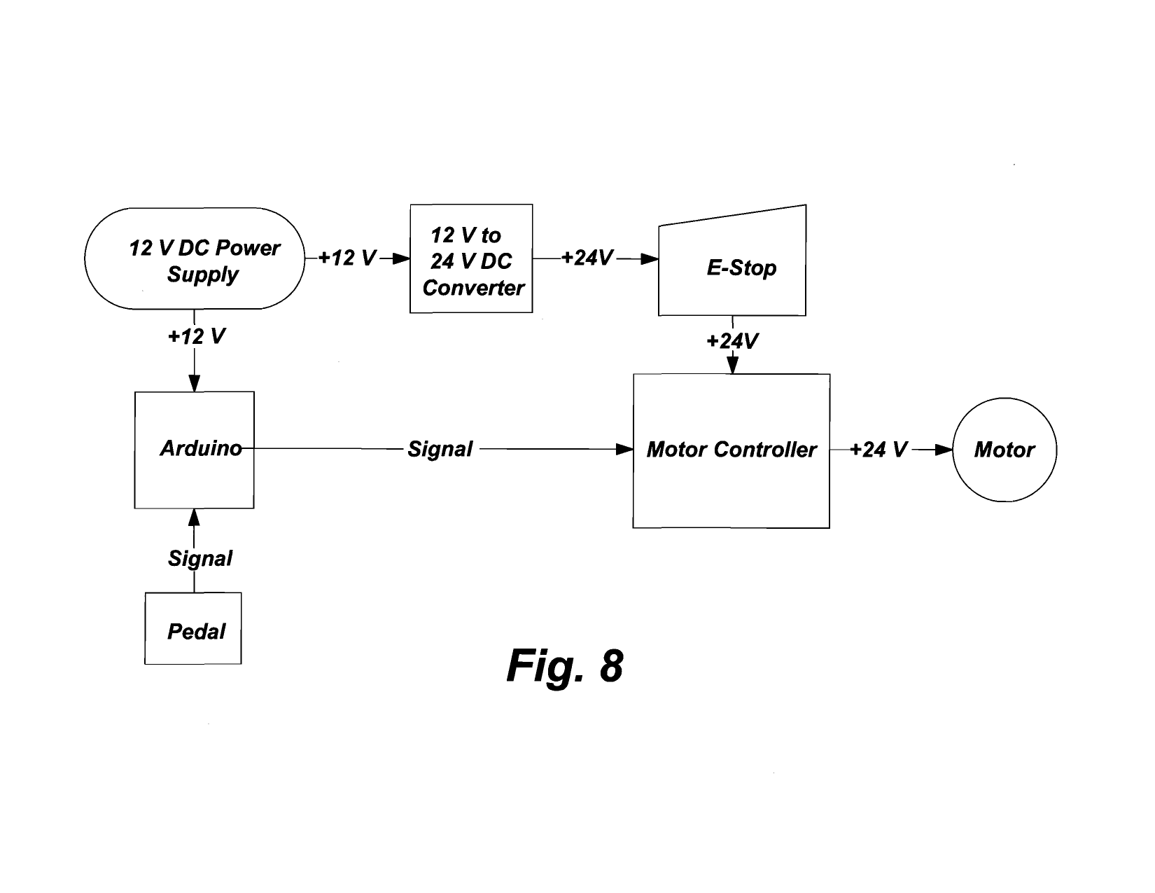

FIG. 8 is a block diagram of the electrical system that will drive the caliper. To provide sufficient power and braking force, in one embodiment a 12V DC powered motor is stepped up to 24V DC using a converter. However, a 12V, 24V, 36V, 48V or 72V system could also be used without the need for a stepper. The brake pedal is used to provide an input to the Arduino servo motor to signal when the motor is to engage. An E-Stop was also installed to prevent accidental power to the motor and to prevent damage to the prototype during non-planned operation.

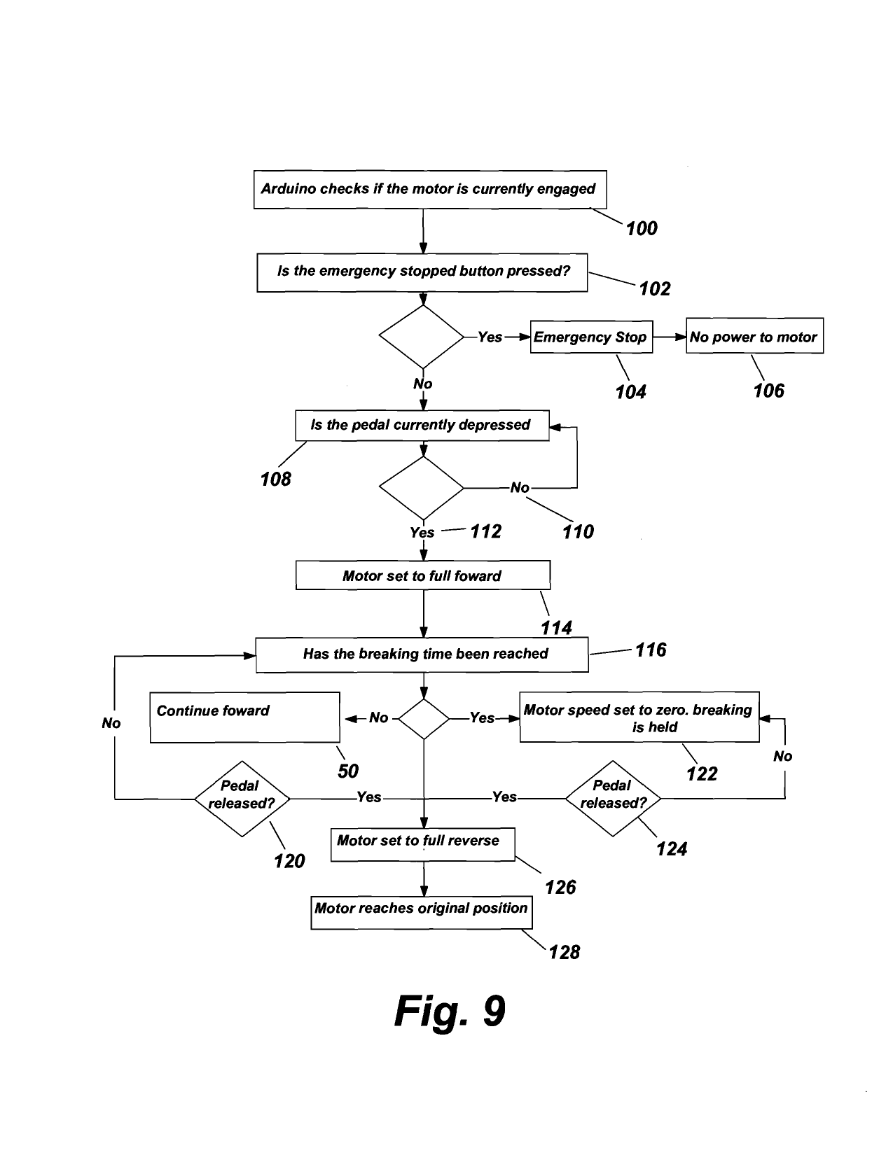

FIG. 8-9 depicts a flowchart wherein the Arduino program is constantly checking for user input on the pedal. Once the program has detected that the brake pedal has been depressed and that the emergency stop button is not engaged, it will allow the motor controller to set the motor to full forward motion. As forward motion occurs, the program will determine if the braking time has been reached and will hold the motor at its final forward position until the pedal is released. Then, the motor controller will be directed to reverse the motor at full speed until the initial position is reached. Once this process is complete, the program is ready to begin another cycle upon another pedal depression. The Arduino code is broken down into main components of initializations, sub loops, and the main loop. The code begins with initializations of the input and output pins of the Arduino board and checks if the motor is engaged 100. Next, there are several sub loops that have all the functions needed in no particular order, these functions range from reading the inputs and setting the motor speed, and the loop that has the full forward and reverse cases with a timer incorporated. A check is made if an emergency stop button 102 is pressed, if pressed as an emergency stop 104 no power is provided to the motor 106. If the emergency button is not pressed a check is determined if the brake pedal is depressed 108. If not depressed the program cycles until the pedal is depressed 112. Depressing of the brake pedal allows the motor set to full forward 114 providing a loop wherein a calculation determines if the braking time has been reach 116, if not the braking continues forward 118 with checks if the pedal has been released 120. If the motor speed is set to zero the braking is held 122 until the pedal has been release 124. Once the pedal is released the motor is set to full reverse 126 until and stops reversing one the motor reaches the original position 128. A main loop, which calls upon each sub loop in correct order to essentially ensure that when a signal is read or not read, the next loop that should run does so. The system is based upon a power supply 130, typically 12V DC. Power 130 is provided to the Arduino logic program 132 which is coupled to a brake pedal 134 for receipt of a signal 136 that the brake pedal 134 has been actuated. The Arduino program 132 instructs the controller 138 which, unless an emergency stop 140 is actuated, provides power stepped up 142 from 12V DC to 24V DC to the electric motor 20.

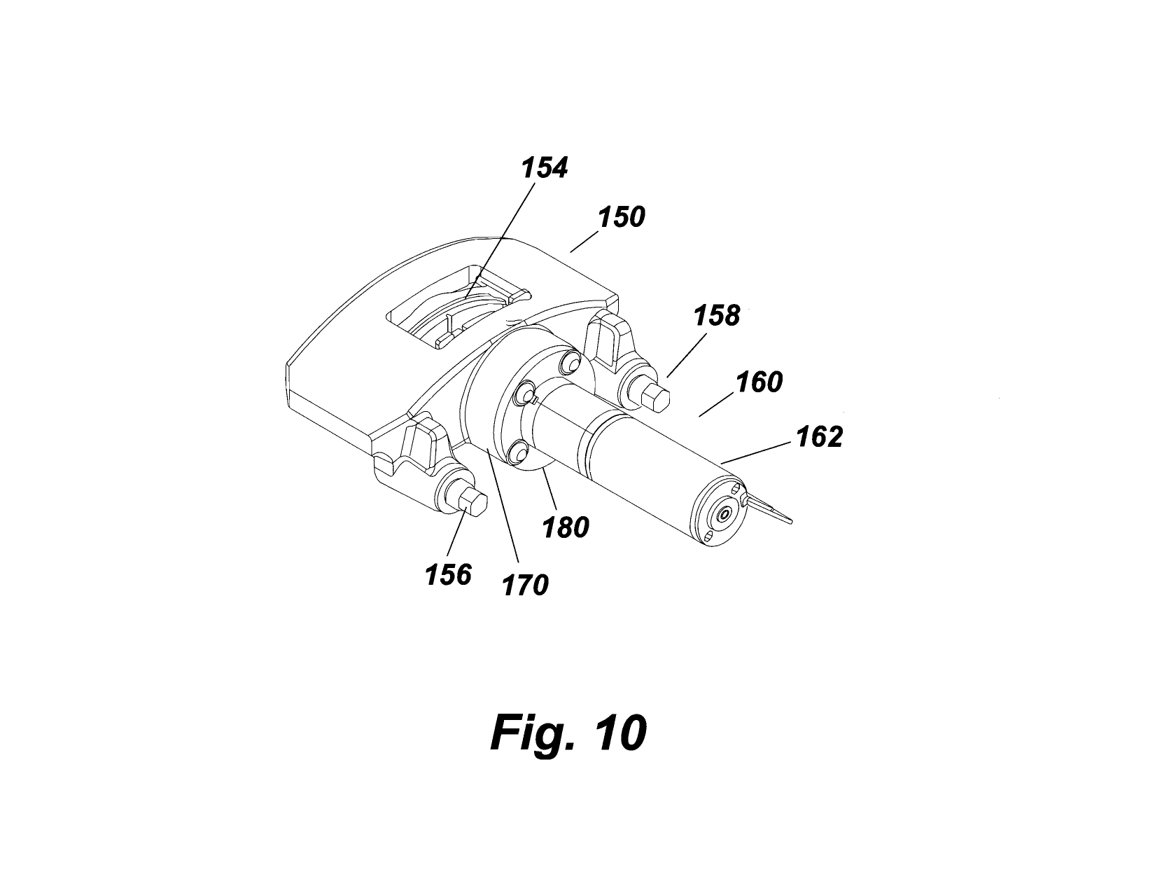

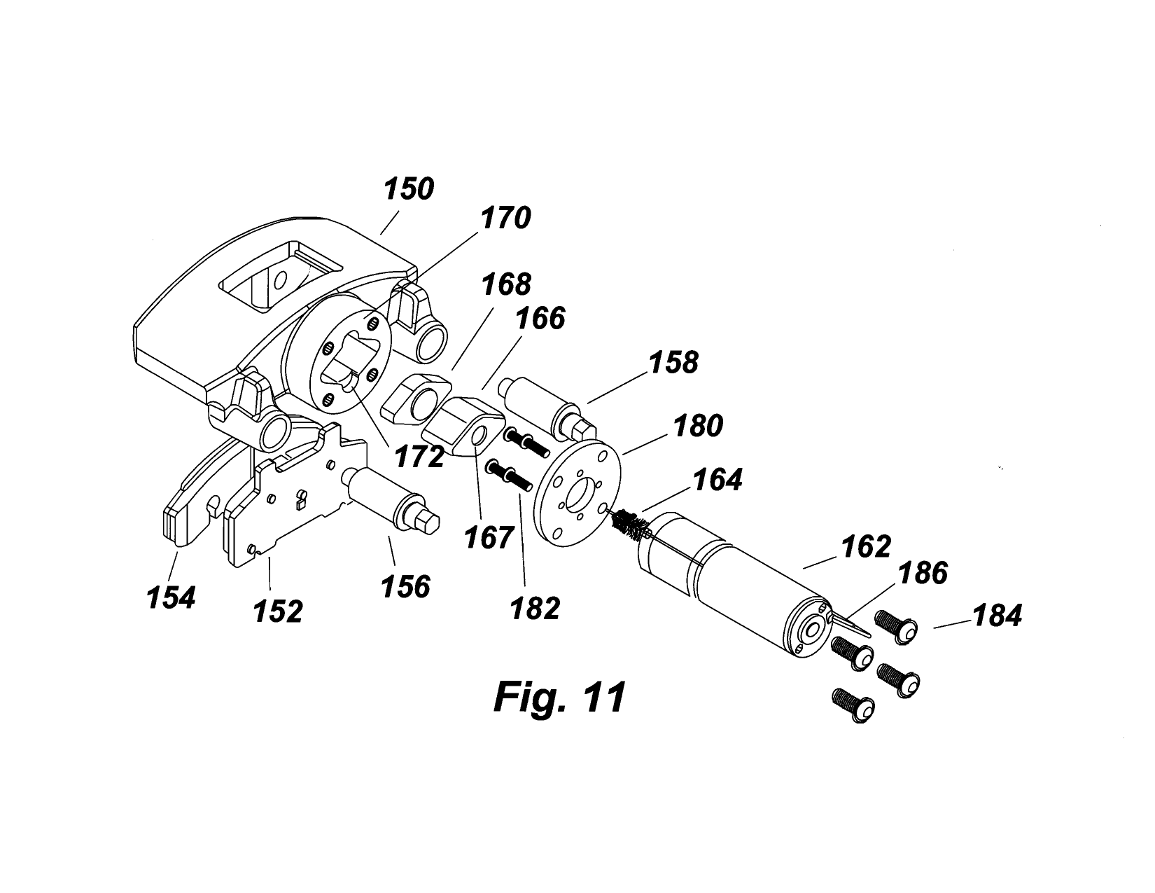

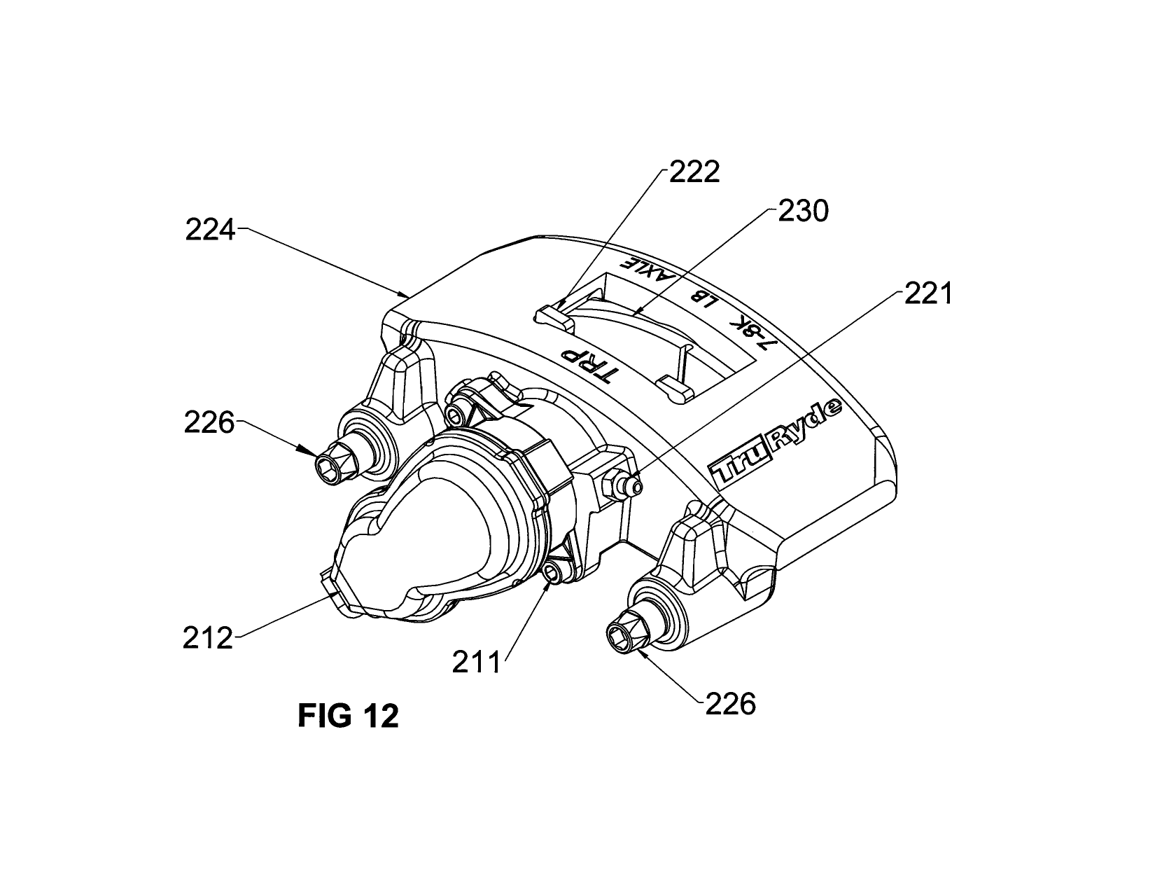

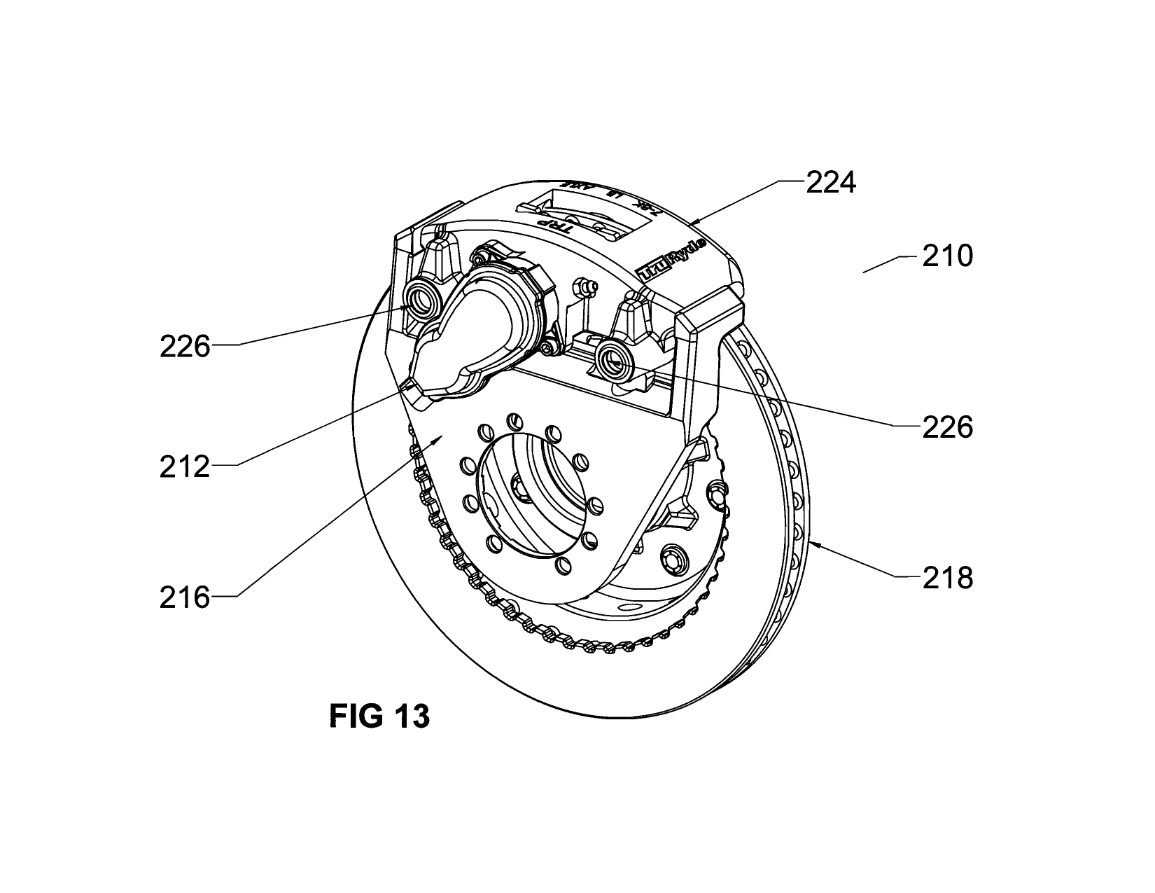

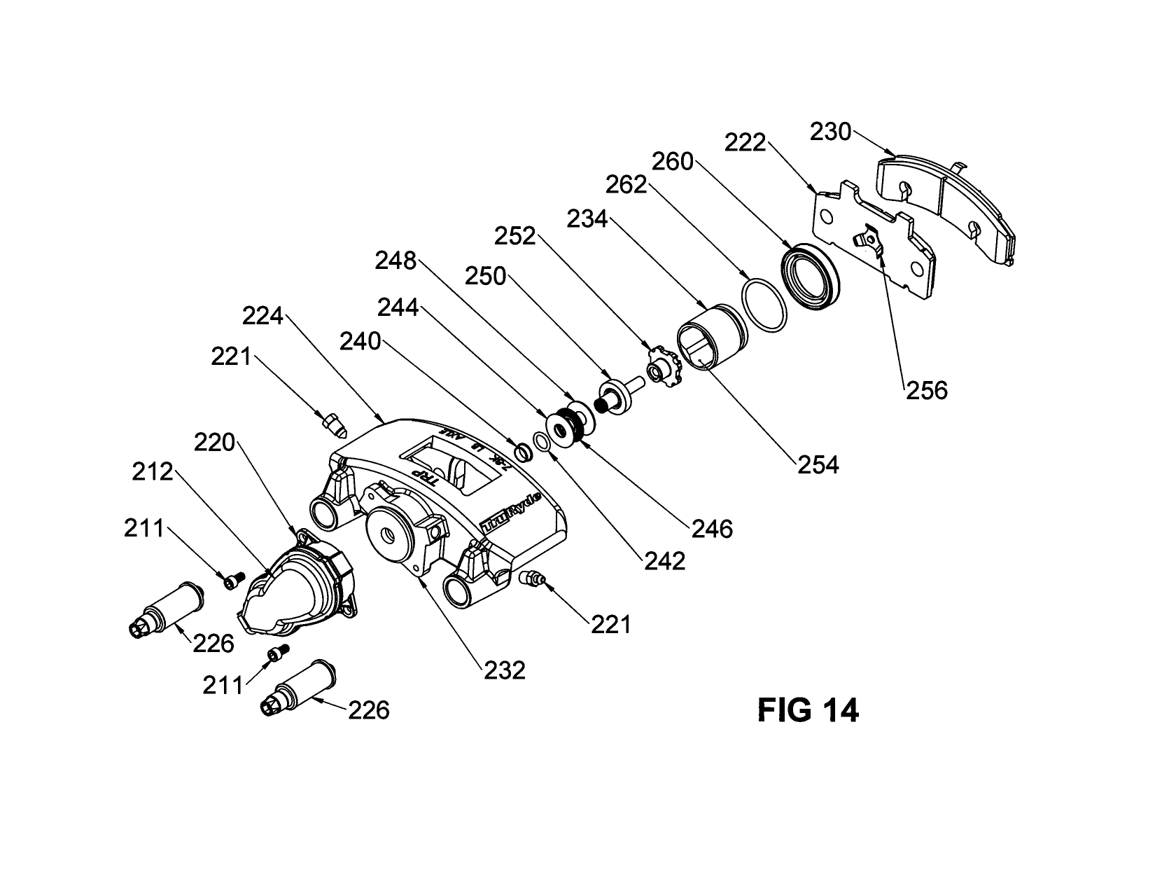

Referring to FIGS. 10-11, illustrated is another embodiment of the electric disc brake system for a trailer comprising a caliper assembly 150 attached to a trailer axle using a mounting bracket 16, the caliper assembly configured to straddle a rotor 18 similar to that depicted in FIG. 1. An inner brake pad 152 is slidably secured to the caliper 150 along an inner surface of a rotor, an outer brake pad 154 is slidably secured to the caliper 150 along an outer surface of the rotor. The caliper 150 is mounted to a mounting bracket with the fasteners 156, 158 which allow the caliper to balance over a rotor. In this embodiment the screw drive assembly 160 employs an electric servo motor 162 having a threaded shaft 164 for engaging a piston 166 having threaded receptacle 167. The piston 166 pushing against a piston plate 168 both of which have an oblong shape for positioning within the piston housing 170 having a reciprocal shaped opening 172. In the preferred embodiment the motor 162 is an Arduino servo motor for rotation of the threaded shaft 164 for linear movement of the piston 166 and piston plate 168 to apply brake force pressure against the brake pad 152. The caliper 150 provides uniform brake pad pressure by movement of the caliber allowing engagement of the outer pad 154 as the inner pad 152 is pressed. A mounted bracket 180 is secured to the motor 162 by fasteners 182. The motor 162 and mounting bracket 180 is secured to the piston housing 170 by fasteners 184. The motor 162 is coupled to a power source and controller by hard wire 186. In operation, the controller monitors user foot pressure on the brake pedal and operates the electric motor to move the piston into engaging the brake pads. The controller engaging the electric motor for a time period with the brake pads held in position until foot pressure is released. The electric motor rotates in a rearward direction to disengage the piston from the brake pads when the brake pedal pressure is removed.

Referring now to FIGS. 1-3, depicted is the electric disc brake assembly 210 of a second embodiment comprising a motor and screw assembly 212 mounted to the caliper assembly 224 with motor mounting bolts 211 to a caliper mounting bracket 216 positioned about a rotor 218. The motor and screw assembly 212 converts rotation of an electric motor 220 into linear motion to push an inner brake pad 222 onto the rotor 218, which causes the entire caliper assembly 224 to move on caliber mounting bolts 226 attaching it to the mounting bracket 216. The caliper assembly 224 moves until the outer brake pad 230 contacts the rotor 218, wherein a clamping force is applied between the brake pads 222 and 230 to slow or stop rotation of the rotor 218. Once the brakes are released, the motor 220 rotates in the opposite direction to release the pressure on the brake pads 222 and 230 against the rotor 218.

The motor and screw assembly 212 is coupled to a motor support 232 which is spaced apart from a drive piston 234 comprising a screw bushing 240 having a small screw O-ring 242 abutting a first washer 244 engaging a bearing 246 with a second washer 248. The drive piston 234 having a screw assembly 250 with adjoining base nut 252, the adjoining base nut 252 constructed and arranged to engage a reciprocal inner chamber 254 of the piston 234. The piston 234 securing to the inner brake pad 222 with attachment bracket 256 engaging a piston boot 260 sealing attached to the piston 234 with a large O-ring 262. Breather plugs 221 are provided for the caliper 224. The motor 220 converting rotation into linear motion by use of the screw assembly 250 to push the inner brake pad 222 onto the rotor 218, which further draws the caliber assembly 224 causing an equal force to be applied against the outer brake pad 230.

The term "coupled" is defined as connected, although not necessarily directly, and not necessarily mechanically. The use of the word "a" or "an" when used in conjunction with the term "comprising" in the claims and/or the specification may mean "one," but it is also consistent with the meaning of "one or more" or "at least one." The term "about" means, in general, the stated value plus or minus 5%. The use of the term "or" in the claims is used to mean "and/or" unless explicitly indicated to refer to alternatives only or the alternative are mutually exclusive, although the disclosure supports a definition that refers to only alternatives and "and/or."

The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a method or device that "comprises," "has," "includes" or "contains" one or more steps or elements, possesses those one or more steps or elements, but is not limited to possessing only those one or more elements. Likewise, a step of a method or an element of a device that "comprises," "has," "includes" or "contains" one or more features, possesses those one or more features, but is not limited to possessing only those one or more features. Furthermore, a device or structure that is configured in a certain way is configured in at least that way, but may also be configured in ways that are not listed.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An electric disc brake system for a trailer coupled to a towing vehicle, comprising:
a caliper assembly configured to straddle a rotor coupled to a wheel of the trailer;
a pair of brake pads carried by the caliper assembly and positioned on opposed sides of the rotor;
an electric drive actuator mounted to the caliper assembly and including an electric motor operatively coupled to a threaded member to convert rotational motion of the motor into linear motion of a piston for applying a clamping force between the brake pads and the rotor; and
a controller electrically coupled to the electric screw drive actuator and configured to receive a braking input signal indicative of movement of a brake pedal in the towing vehicle, drive the electric motor in a forward direction to advance the piston and apply a braking force when the braking input signal exceeds a threshold; and drive the electric motor in a reverse direction to retract the piston and release the braking force when the braking input signal falls below the threshold;
wherein the controller maintains the piston in an engaged braking position without further rotation of the electric motor until the braking input signal falls below the threshold.

2. The electric disc brake system of claim 1, wherein the controller determines the threshold based on pedal position, pedal pressure, towing vehicle inertia, or an emergency stop signal.

3. The electric disc brake system of claim 1, wherein the controller drives the electric motor at a higher speed during piston retraction than during piston advancement.

4. The electric disc brake system of claim 1, wherein the piston is prevented from rotating relative to the caliper assembly.

5. The electric disc brake system according to claim 1 wherein said threaded shaft is operatively connected to the electric motor, said threaded shaft converting rotational motion of the electric motor into linear motion for movement of said piston.

6. . The electric disc brake system according to claim 1 wherein said electric motor operates between 12 VDC and 72 VDC.

7. The electric disc brake system according to claim 3 including a converter to operate said electric motor on 12V DC wherein the converter steps the voltage to 24V DC.

8. The electric disc brake system of claim 1, wherein the brake pads are positioned between about 0.02 inches and about 0.08 inches from the rotor when no braking force is applied.

9. The electric disc brake system of claim 1, further comprising a voltage converter configured to receive DC power from the towing vehicle and supply corrected DC power to the electric motor.

10. The electric disc brake system of claim 1, wherein the controller applies a predetermined braking force for a predetermined time period in response to an emergency stop input.

11. The electric disc brake system according to claim 1 wherein said motor is an electric servo motor for rotation of said threaded shaft for linear movement of said piston and a piston plate to apply brake force pressure against said inner brake pad.

12. The electric disc brake system according to claim 1 wherein said controller monitors user foot pressure against said brake pedal, said controller operating said electric motor to rotate said threaded shaft in a forward direction to engage said brake pads in a predetermined position until the foot pressure is released wherein said electric motor is reversed to disengage brake force against said brake pads.

13. The electric disc brake system according to claim 1 wherein each said brake pad is positioned about 0.05 inches from the rotor when no pressure is applied to the brake pedal.

14. The electric disc brake system according to claim 1 including an emergency stop coupled to said controller.

15. The electric disc brake system according to claim 1 wherein said electric motor includes a converter to step said motor to 24V DC.

16. The electric disc brake system according to claim 14 wherein said piston and said piston plate are oblong in shape and positioned within a reciprocal-shaped piston housing to prevent rotation of the piston during operation.
